(19) United States
(12) Patent Application Publication
(10) Pub. No.: US 2026/0208253 A1
(43) Pub. Date: Jul. 23, 2026

(54) LONGITUDINAL CHAMBER PROFILE PREFORM AND METHOD

(71) Applicant: ZIETA PROZESSDESIGN SPOLKA Z OGRANICZONA ODPOWIEDZIALNOSCIA, Wroclaw (PL)

(72) Inventor: Oskar Zieta, Wroclaw (PL)

(21) Appl. No.: 19/568,171

(22) Filed: Mar. 16, 2026

Related U.S. Application Data
(63) Continuation of application No. PCT/IB2024/058982, filed on Sep. 16, 2024.

(30) Foreign Application Priority Data
Sep. 18, 2023 (PL) P.446144

(51) Int. Cl. B21D 26/051; B21D 26/045; B21D 39/02

(52) U.S. Cl. CPC B21D 26/051; B21D 26/045; B21D 39/028

(57) ABSTRACT

A preform (1) adapted to produce a longitudinal chamber profile element (7) includes an inner wall (2) and an outer wall (3). Each of the exemplary walls is comprised of deformable metal sheet. The inner wall short edges (14) and outer wall short edges (10) are sealed in fluid tight relation by short seals (6) and the inner wall long edges (16) and the outer wall long edges (12) are sealed in fluid tight relation by long seals (26). The inner and outer walls along with the seals bound a fluid tight sealed gap also referred to as an inner space (4), between the walls. A valve (5) is adapted to deliver pressurized fluid to the sealed inner space. The preform is coiled in a shape that is substantially an Archimedean spiral. Pressurized fluid delivered into the sealed inner space causes deformation of the inner and outer walls and the preform to uncoil to form the longitudinal chamber profile element.

### TECHNICAL FIELD

Exemplary arrangements relate to structural and/or to decorative elements and methods of manufacturing such items. Exemplary arrangements specifically relate a longitudinal chamber profile preform that has a spiral shape. The longitudinal chamber profile preform is comprised of spiral shaped deformable metal sheets that bound a sealed elongated spiral shape fluid tight gap between the sheets. The introduction of pressurized fluid to the gap causes deformation of the metal sheets and causes the spiral shape to uncoil and straighten producing a longitudinal chamber profile element that has a substantially greater longitudinal length dimension than the spiral shape preform.

### BACKGROUND

Preforms comprised of metal sheets that bound a fluid tight cavity may be formed to produce decorative or structural elements having desired shapes through the application of fluid pressure to the cavity. Such preforms are used to produce structural members such as vehicle parts that are used in the automotive industry. Such preforms may be used in the production of frames, bodies, doors and/or hoods of vehicles for example. Such preforms may also be used to produce structural members used in the construction industry. Structural members such as wall panels, ceilings, doors, trusses, beams, supports and other components may be produced using such preforms. Decorative elements used in the furniture industry or for other types of ornamentation may be produced using such preforms.

Commonly, prior longitudinal chamber profile preforms have a longitudinal length that closely corresponds to the final desired length of the final structural element or decorative element to be produced. The fact that the preforms and the components thereof have an initial longitudinal length dimension that closely corresponds to the final longitudinal length dimension of the element being produced, may pose transportation and/or logistical challenges. This is particularly the case for profile preforms that are of a significant length.

Existing preforms adapted to produce longitudinal chamber profile elements and methods for producing longitudinal chamber profile elements may benefit from improvements.

### SUMMARY

Exemplary arrangements relate to an apparatus including a preform adapted to produce a longitudinal chamber profile element. The exemplary preform may be used to produce structural or decorative elements. The exemplary preforms are particularly useful in situations where the final element to be produced through the use of the preform has a longitudinal length dimension that is substantially greater than the initial dimensions of the preform.

The exemplary longitudinal chamber profile preform includes an inner wall comprised of metal sheet. The inner wall includes two opposite inner wall short edges and two opposite inner wall long edges. Each inner wall short edge bounds a respective end of the inner wall. The exemplary preform further includes an outer wall comprised of metal sheet. The outer wall includes two opposite outer wall short edges and two opposite outer wall long edges. Each outer wall short edge bounds a respective end of the outer wall. In exemplary arrangements the inner wall and the outer wall have similar dimensions and configurations and are arranged in the preform with the respective edges in generally aligned relation.

The exemplary preform includes a pair of short seals and a pair of long seals. Each respective inner wall short edge is joined and sealed in fluid tight relation with a respective outer wall short edge by a respective short seal. Each respective inner wall long edge is joined in sealed fluid tight relation with a respective outer wall long edge by a respective long seal. Short seals and long seals may comprise for example, fusion welds, pressure welds, a layer of adhesive, a lap joint or other suitable seal. A hermetically sealed initially unoccupied internal gap which is alternatively referred to herein as a pressure tight hermetic inner space, extends within the preform intermediate of the inner wall and the outer wall and intermediate of the short seals and the long seals.

The exemplary preform further includes a valve. The exemplary valve is positioned on one of the inner wall or the outer wall, and is adapted to enable the introduction of pressurized fluid through the valve, the respective wall, and into the gap. In exemplary arrangements the valve may comprise a check valve that is adapted to enable pressurized fluid to be delivered into the gap and prevents the escape of fluid therefrom.

The exemplary preform prior to the introduction of pressurized fluid into the gap, is coiled such that each of the long seals and the inner and outer wall long edges in a side view have a shape that is substantially an Archimedean spiral.

In some exemplary arrangements a longitudinal chamber profile element is produced by introducing fluid pressure into the gap of the preform through the valve and maintaining the fluid pressure at a level that is operative to cause each of the inner wall and the outer wall to deform. The application of the fluid pressure is operative to cause the spiral of the preform to uncoil and straighten which results in the exemplary formed structural element having a much greater longitudinal dimension than the initial preform. As used herein when referring to the preform and the profile element produced from the preform, longitudinal shall mean lengthwise in a relatively linearly straight direction. For purposes of this definition, relatively linearly straight shall mean linearly straight or an arc curved through an angle no greater than 90°.

In some exemplary arrangements the pressurized fluid may include compressible or incompressible fluids such as gas, air, water, oil, foam, fluid concrete or fluid plastic. In some arrangements the pressurized fluid may be drained from the interior of the structural element after formation to the final shape while in other arrangements the fluid may remain within the chamber. In the case of certain fluids, the fluid may cure and/or harden within the chamber after deformation of the walls, further increasing the strength of the element.

Numerous different approaches and apparatus may be utilized in producing suitable longitudinal chamber profile preforms and in the production of elements usable as structural or decorative members from such preforms as described in the following Detailed Description.

### BRIEF DESCRIPTION OF DRAWINGS

FIG. 1 is a perspective view of an exemplary longitudinal chamber profile preform.

FIG. 2 is a side view of an exemplary longitudinal chamber profile produced using the preform shown in FIG. 1.

FIG. 3 is a top view of the longitudinal chamber profile shown in FIG. 2.

FIG. 4 is a top axially transverse cross-sectional view of an exemplary longitudinal chamber profile preform.

FIG. 5 is a cross-sectional view of an exemplary longitudinal chamber profile formed from the longitudinal chamber profile preform of FIG. 4.

FIG. 5A is an enlarged view of the circled portion of the longitudinal end of the longitudinal chamber profile in FIG. 5.

FIGS. 6 A through E are side views of progressive pressure deformation and changes in shape of an exemplary longitudinal chamber profile preform in an exemplary manufacturing method to produce a longitudinal chamber profile element.

FIGS. 7 A through D are side views of an exemplary longitudinal profile preform and an apparatus utilized in straightening the exemplary preform in an exemplary manufacturing method to produce a rectilinear longitudinal chamber profile element.

### DETAILED DESCRIPTION

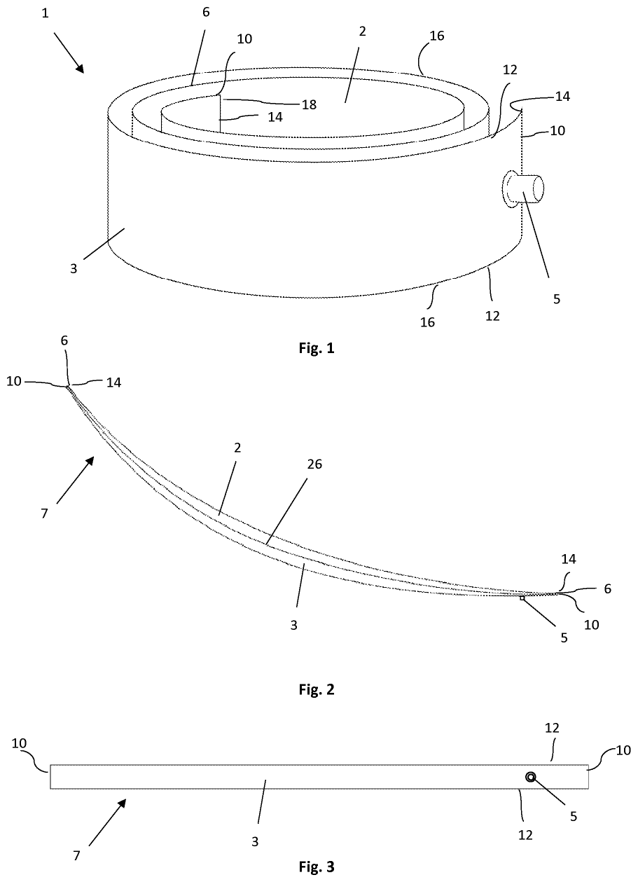

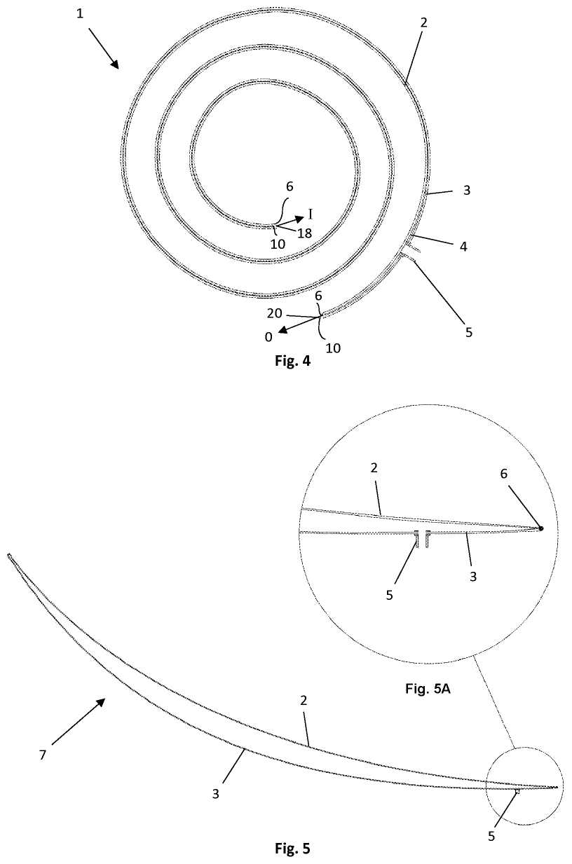

Referring now to the drawings and particularly to FIG. 1 there is shown therein an exemplary longitudinal chamber profile preform 1. The exemplary preform includes a rectangularly shaped elongated outer wall 3. The exemplary outer wall 3 is comprised of metal sheet that is adapted to be pressure deformable in a manner like that later discussed. The exemplary outer wall is bounded by a pair of opposite outer wall short edges 10 which each bound a respective end of the outer wall. The outer wall is further bounded by a pair of opposite outer wall long edges 12. Each of the outer wall long edges 12 extends between the opposite outer wall short edges 10.

The exemplary preform further includes an inner wall 2. The inner wall 2 is also comprised of metal sheet similar to the outer wall 1. The inner wall includes two opposite inner wall short edges 14, each of which inner wall short edges bounds a respective end of the inner wall. The inner wall further includes two opposite inner wall long edges 16. In the exemplary arrangement of the preform 1, the respective inner wall short edges 14 and the outer wall short edges 10 are arranged in generally aligned relation. Similarly, the respective inner wall long edges 16 and the outer wall long edges 12 are arranged in generally aligned relation.

For purposes hereof generally aligned relation of edges means for the short edges that the short edge of one wall does not extend outward beyond the immediately adjacent short edge of the other wall a distance that is greater than 10% of the distance on the surface of the inner wall between the opposed inner wall short edges of the preform. Likewise generally aligned relation for the long edges means that one long edge on a respective wall does not extend laterally outward beyond the immediately adjacent long edge of the other wall a distance that is greater than 10% of the lateral distance on the surface of the inner wall between the opposed inner wall long edges. Of course it should be understood that while in the exemplary arrangement each respective inner wall short edge is in generally aligned relation with a respective outer wall short edge, and each inner wall long edge is in generally aligned relation with the respective outer wall long edge, and while that configuration is useful, other exemplary arrangements need not include this feature and may have other configurations.

As shown for example in FIG. 4, in the exemplary coiled preform a transverse radial gap extends between the radially inner surface of the outer wall 3 and the radially outer surface of the inner wall 2. In the exemplary arrangement each respective inner wall short edge 14 is joined in sealed fluid tight relation with a respective outer wall short edge 10 by a respective short seal 6. Similarly each respective inner wall long edge 16 is joined in sealed fluid tight relation with a respective outer wall long edge 12 by a respective long seal 26. As a result, the inner wall 2 and outer wall 3 and the short seals 6 and the long seals 26 bound a pressure tight hermetic sealed inner space 4 which is alternatively referred to herein as a fluid tight gap. In exemplary arrangements the gap within the preform is initially unoccupied except for example by air at an ambient pressure that is present when the hermetic gap is sealed.

In exemplary arrangements the short seals and long seals may comprise suitable types of seals including for example fusion welds, pressure welds, soldered connections, glued connections, layers of adhesive, lap joints, bend joints, pressed joints or other suitable seal types that are operative to maintain the inner wall and the outer wall in sealed fluid tight relation in the range of pressures that are applied to the fluid tight gap to cause the preform to be deformed responsive to the internal pressure forces to produce the longitudinal chamber profile. In some exemplary preform arrangements the inner wall and the outer wall may converge at each immediately adjacent inner wall short edge and outer wall short edge. Similarly, in some exemplary preform arrangements the inner wall and the outer wall may converge at each immediately adjacent inner wall long edge and outer wall long edge. Such a convergent configuration may help to assure that the pressure tight sealed inner space 4 extends along and through the entire sealed inner space of the preform.

In the exemplary preform arrangement the inner and outer surfaces of each of the inner wall 2 and the outer wall 3 of the longitudinal chamber profile preform, as well as each of the long seals 26 thereof are arranged in the shape of a spiral. In the exemplary arrangement the spiral extends outward from an inner end 18 to an outer end 22 and through an angle of at least 900°. In the exemplary arrangement the walls and long seals of the preform in a side view are coiled so as to have a shape that is substantially an Archimedean spiral. As used herein a shape that is substantially an Archimedean spiral means that a majority of the shape corresponds to a profile of an Archimedean spiral. It should be understood however that while in the exemplary arrangement the Archimedean spiral configuration is useful to help in pressure distribution within the inner space of the preform, in other preform arrangements other types of spiral arrangements the be used.

In the exemplary arrangement of the preform 1, the inner end 18 of the spiral, at which an inner wall short edge is in sealed relation with the outer wall short edge through a short seal 6, faces in an inner end direction represented by Arrow I. Further in the exemplary arrangement the outer end of the spiral 20, at which the other inner wall short edge is in sealed relation with the other outer wall short edge through a short seal 6, faces in an outer end direction which is represented by Arrow O. In the exemplary arrangement the inner end direction is substantially opposite to the outer end direction. For purposes hereof substantially opposite when referring to the end directions means that the outer end direction differs by an angle greater than 130° from the inner end direction.

The exemplary longitudinal profile preform includes a valve 5. The exemplary valve is adapted to enable the introduction of pressurized fluid into the fluid tight sealed gap 4 that extends intermediate of the walls and the seals. In the exemplary arrangement the valve 5 enables the introduction of pressurized fluid through the valve and the outer wall 3. However it should be understood that in other arrangements the valve may enable the introduction of fluid to the gap through the inner wall. Further in other exemplary arrangements multiple valves may be provided on the outer wall, on the inner wall, or on each of the walls. The exemplary valve comprises a check valve that is adapted to enable pressurized fluid to enter the sealed fluid tight inner space or gap, and to hold the pressure by preventing the escape of fluid through the valve. However, it should be understood that this type of valve while useful, is exemplary and in other arrangements other types of valves or fluid passage and delivery structures may be used.

In the exemplary arrangement the valve 5 is positioned in close proximity to the outer end 20 of the spiral of the preform. When it is stated herein that the valve is in close proximity to the outer end of the spiral, it means that the valve is within a 45° angle along the spiral from the outer end of the spiral. In some arrangements this configuration is useful for facilitating access to the valve to enable the introduction of fluid into the sealed inner space 4 between the inner and outer walls of the preform in the spiral configuration.

In exemplary arrangements the longitudinal chamber profile preform may be manufactured starting with the inner and outer walls initially in generally flat parallel relation with the respective long edges and respective short edges of the walls in generally aligned relation. The inner wall short edges and the outer wall short edges may be joined together with respective short seals and the inner wall long edges and the outer wall long edges may be joined together with respective long seals. The valve may be installed on one of the inner wall or the outer wall. Once the precursor to the exemplary preform has been assembled in this manner, the structure can be coiled in a suitable outward expanding spiral shape from the inner end 18, which in the exemplary arrangement is a shape that is substantially an Archimedean spiral. After the longitudinal chamber profile preform is assembled and coiled in this manner, the spiral can be tightened or otherwise adjusted and/or made to conform to a suitable size for purposes of packaging, transportation and/or storage.

The exemplary longitudinal chamber profile preform 1 may be utilized to manufacture a longitudinal chamber profile 7 which is alternatively referred to herein as a longitudinal chamber profile element. In the exemplary arrangement an external source of pressurized fluid is connected to the valve 5 and pressurized fluid is delivered into the fluid pressure tight gap 4 that extends between the walls. In some exemplary arrangements the pressurized fluid may comprise air and the source of fluid pressure may comprise an air compressor. However it should be understood that this pressurized fluid is exemplary and in other arrangements the pressurized fluid that is delivered into the inner space 4 of the preform may be other types of compressible or incompressible fluids. Such fluids may include for example gas, water, fluid cement, machine oil, fluid plastic such as a one, two, or three component foam (such as a flex 140 type material) or other suitable fluids.

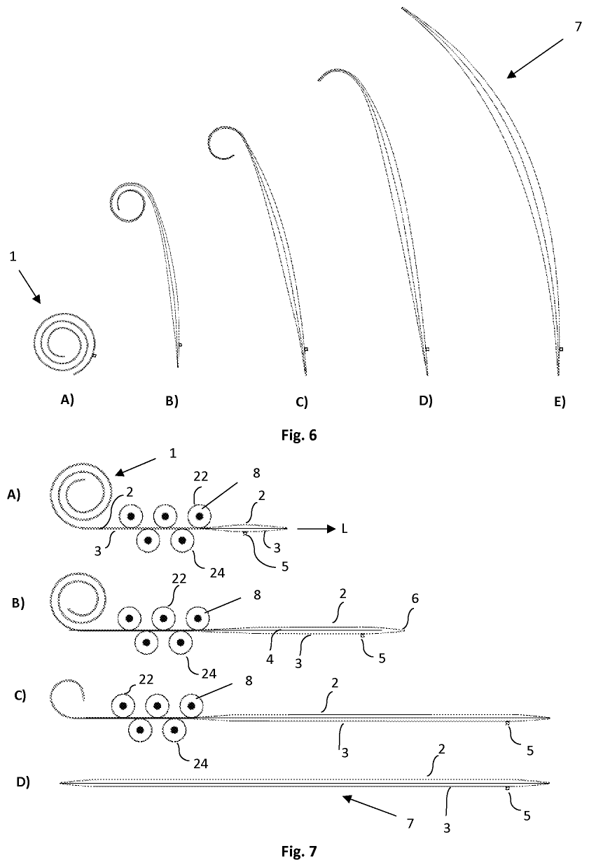

The exemplary pressurized fluid is delivered at a suitable high pressure to the fluid pressure tight hermetic inner space 4 of the longitudinal chamber profile preform. The high pressure fluid is delivered to the inner space and maintained for a suitable time at the elevated pressure so as to cause the inner wall 2 and the outer wall 3 to undergo controlled deformation. In exemplary arrangements as the inner and outer walls deform the spiral of the longitudinal chamber profile preform uncoils and straightens such as is shown in FIGS. 6 A through 6 E. In exemplary arrangements the spiral of the longitudinal chamber profile preform uncoils and straightens as the walls are deformed responsive to the internal fluid pressure. When the longitudinal chamber profile element has been formed from the preform, the joined short edges of the inner and outer walls comprise the respective longitudinal ends of the element.

In exemplary arrangements the pressurized fluid is delivered into the pressure tight hermetic sealed inner space at room temperature and thus the longitudinal profile formation is a cold technology. However, it should be understood that in other exemplary arrangements the process may be carried out at elevated, high or even subzero temperatures. For example some exemplary preform arrangements may be adapted to undergo deformation and expansion at pressures and temperatures that are encountered in outer space environments and may be adapted to produce useful structural elements for spacecraft such as shields and solar sails.

In an exemplary arrangement such as that represented in FIGS. 6 A through E, the fluid delivered into the inner space of the preform has a working pressure of 5 bars (500 KPa). The exemplary preform undergoes controlled deformation during an initial deformation time of 1 minute, which in the exemplary arrangement enables the pressure to be equalized within the hermetically sealed inner space of the chamber profile preform. During this time the spiral uncoils and the length dimension increases as represented in the Figures. Subsequent to the initial deformation time, the working pressure is held on the inner space for at least 30 seconds to undergo final deformation changes and assure that the walls take on a permanent set shape. As a result, in this exemplary arrangement the total deformation time of the preform structure to produce the longitudinal profile element is 1.5 minutes. Of course it should be understood that this method while useful, is exemplary and in other arrangements other methods and process steps and process parameters may be used.

In other exemplary arrangements the spiral shaped preform may undergo externally applied straightening forces as part of the process for producing the longitudinal chamber profile. An example apparatus for applying straightening forces to the preform is represented in FIGS. 7 A through D. In this exemplary arrangement the preform is positioned between a plurality of first rolls 22 and at least one second roll 24 of a straightening roll system 8. In the exemplary arrangement each first roll 22 is longitudinally disposed from each of the other first rolls. When referring to the roll system 8 or movement of the preform through the rolls of the roll system herein, longitudinally refers to a direction L along which direction the preform moves when between the first rolls and second rolls.

In the exemplary arrangement a plurality of second rolls are longitudinally disposed from each of the other second rolls 24. At least one second roll is positioned longitudinally intermediate of an immediately longitudinally adjacent pair of first rolls. In the exemplary arrangement as shown, a plurality of respective second rolls are positioned so as to be longitudinally intermediate of an immediately longitudinally adjacent pair of first rolls so as to facilitate straightening. In the exemplary arrangement each of the first rolls 22 rotate about a respective axis and have outer surfaces that move in engagement with the inner wall 2. Each of the second rolls 24 also each rotate about a respective axis and have outer surfaces that move in engagement with the outer wall 3.

In the manufacture of the longitudinal chamber profile element 7 from the preform as represented in FIGS. 7 A through 7 D, the valve 5 is positioned longitudinally on a first side of the first rolls 22 and the second rolls 24. Pressurized fluid is introduced to the fluid tight inner space 4 through the valve. The introduction of the fluid pressure to the sealed inner space 4 causes deformation of the inner wall 2 and the outer wall 3. In the exemplary arrangement the deformation of the inner and outer walls exerts a force that acts longitudinally on the first rolls and the second rolls, the axes of which are in fixed positions. The force applied to the rolls as a result of deformation of the walls causes the straightened portion of the preform to move longitudinally away from the rolls in the direction of Arrow L.

In the exemplary arrangement the further deformation of the inner and outer walls causes the preform to move longitudinally without the need for a separate device to rotate the first and second rolls. As the preform expands toward the final profile configuration, the remainder of the preform having the spiral shape is progressively reduced. As the preform passes between the first rolls and second rolls the coiled preform is progressively straightened and expanded due to pressure deformation of the walls. When the profile has been fully formed as shown in FIG. 7 D for example, the exemplary profile is rectilinear and has a much greater longitudinal length than the initial coiled preform.

Of course it should be understood that this approach is exemplary and in other arrangements a powered straightening roll system may be utilized to straighten the spiral shape preform either before fluid pressure is applied or as fluid pressure is being applied to the fluid tight sealed inner space or gap of the preform.

As can be appreciated the exemplary arrangements enable the production of an element including a longitudinal chamber profile having desired properties and a defined geometry, while maintaining high dimensional accuracy. Further the exemplary arrangements enable producing a longitudinal chamber profile through a small number of steps which provides for a simple and less time consuming manufacturing process. Further numerous different type longitudinal chamber profile elements can be produced without specialized tooling or operations.

The exemplary arrangements further enable producing longitudinal chamber profiles with less material content and in a wide variety of temperature and pressure environments. The exemplary preforms enable the manufacture of elements with a wide range of geometrical parameters and shapes. As can be appreciated longitudinal chamber profile elements of different heights, spatial forms and with symmetrical or asymmetrical profiles may be produced. Exemplary elements may be produced having straight rectilinear profile characteristics or curved profile characteristics as desired. Exemplary elements can also be produced using manufacturing methods that allow the shape of the longitudinal chamber profiles to be modified without the need to rearrange the devices that are utilized in the manufacturing process. Profile elements having relatively long longitudinal lengths compared to the largest dimension of the initial spiral preform can be produced.

Exemplary arrangements enable longitudinal chamber profile elements to be produced using a wide variety of compressible and incompressible pressurized fluids. The use of such fluids enables the production of elements with different properties and configurations. Further exemplary elements may be produced using pressurized fluids that can be removed after preform deformation or that may remain in place within the inner space of the element and/or which may cure, solidify, harden or otherwise provide useful properties for the element. Such pressurized fluids may include for example, fluid concrete, foams or curable plastics.

Thus the exemplary arrangements achieve improved operations and capabilities, eliminate difficulties encountered in the use of prior arrangements, and attain the useful results that are described herein.

In the foregoing description certain terms have been used for brevity, clarity and understanding. However no unnecessary limitations are to be implied therefrom because such terms are used for descriptive purposes and are intended to be broadly construed. Moreover the descriptions and illustrations herein are by way of examples and the new and useful features, relationships and steps are not limited to the exact features, relationships and steps that have been shown and/or described.

Having described features, discoveries and principles of the exemplary arrangements, the manner in which they are constructed, produced and operated, and the advantages and useful results attained, the new and useful features, apparatus, devices, elements, arrangements, parts, combinations, systems, equipment, operations, methods, processes and relationships are set forth in the appended claims.

I claim:

1. Apparatus comprising:
a preform adapted to produce a longitudinal chamber profile element, including an inner wall, wherein the inner wall
is comprised of metal sheet,
includes two opposite inner wall short edges and two opposite inner wall long edges, wherein a respective inner wall short edge bounds a respective end of the inner wall,
an outer wall, wherein the outer wall
is comprised of metal sheet,
includes two opposite outer wall short edges and two opposite outer wall long edges, wherein a respective outer wall short edge bounds a respective end of the outer wall,
a pair of short seals,
wherein each respective inner wall short edge is joined in sealed fluid tight relation with a respective outer wall short edge by a respective short seal,
a pair of long seals,
wherein each respective inner wall long edge is joined in sealed fluid tight relation with a respective outer wall long edge by a respective long seal,
wherein a hermetic sealed internal gap extends intermediate of the inner wall and the outer wall and intermediate of the short seals and the long seals,
a valve, wherein the valve
is positioned on one of the inner wall or the outer wall, and
is adapted to enable the introduction of pressurized fluid to the gap,
wherein the preform prior to the introduction of pressurized fluid into the gap is coiled such that each of the long seals in a side view have a shape that is substantially an Archimedean spiral.

2. The apparatus according to claim 1
wherein the inner wall converges with the outer wall at each inner wall short edge.

3. The apparatus according to claim 1
wherein the valve comprises a check valve adapted to enable fluid to enter the gap and prevent fluid from escaping from the gap through the valve.

4. The apparatus according to claim 1
wherein the short and long seals comprise one or more of
a fusion weld,
a pressure weld,
a layer of an adhesive, or
a lap joint.

5. The apparatus according to claim 1
wherein the valve extends on the outer wall in close proximity to an outer end of the Archimedean spiral.

6. The apparatus according to claim 1
wherein the preform is coiled from an inner end to an outer end, wherein the inner end faces in an inner end direction and the outer end faces in an outer end direction,
wherein the inner end direction is substantially opposite to the outer end direction.

7. The apparatus according to claim 1
wherein fluid introduced to the gap through the valve is operative to cause each of the inner wall and the outer wall to deform and the shape of the spiral to uncoil.

8. The apparatus according to claim 1
wherein fluid introduced to the gap through the valve and maintained for at least 30 seconds at a fluid pressure of at least 500 kPa is operative to cause each of the inner wall and the outer wall to deform and the shape of the spiral to uncoil.

9. The apparatus according to claim 1
and further comprising:
a plurality of first rolls, wherein the first rolls are engaged with the inner wall,
a plurality of second rolls, wherein the second rolls are engaged with the outer wall,
wherein engagement of the preform with the first rolls and the second rolls is operative to straighten the shape of the preform.

10. The apparatus according to claim 1
and further comprising:
a plurality of first rolls, wherein the first rolls
are each engaged with the inner wall,
are each longitudinally disposed from each of the other first rolls,
a plurality of second rolls, wherein the second rolls
are each engaged with the outer wall,
are each longitudinally disposed from each of the other second rolls,
wherein at least one second roll is positioned longitudinally intermediate of an immediately longitudinally adjacent pair of first rolls,
wherein engagement of the preform with the first rolls and the second rolls is operative to straighten the shape of the preform.

11. The apparatus according to claim 1
and further comprising:
a plurality of first rolls, wherein the first rolls are engaged with the inner wall,
a plurality of second rolls, wherein the second rolls are engaged with the outer wall,
wherein engagement of the preform with the first rolls and the second rolls as the preform is moved relative to the rolls is operative to straighten the shape of the preform.

12. The apparatus according to claim 1
and further comprising:
a plurality of first rolls, wherein the first rolls
are each engaged with the inner wall,
are each longitudinally disposed from each of the other first rolls,
a plurality of second rolls, wherein the second rolls
are each engaged with the outer wall,
are each longitudinally disposed from each of the other second rolls,
wherein at least one second roll is positioned longitudinally intermediate of an immediately longitudinally adjacent pair of first rolls,
wherein movement of the preform longitudinally relative to and in engagement with the first rolls and the second rolls is operative to straighten the shape of the preform.

13. The apparatus according to claim 1
and further comprising:
a plurality of first rolls, wherein the first rolls
are engaged with the inner wall,
are each longitudinally disposed from each of the other first rolls,
at least one second roll, wherein the at least one second roll
is engaged with the outer wall,
is positioned longitudinally intermediate of an immediately longitudinally adjacent pair of first rolls,
wherein movement of the preform longitudinally relative to and in engagement with the first rolls and the at least one second roll is operative to straighten the shape of the preform,
wherein fluid introduced to the gap through the valve is operative to cause
each of the inner wall and the outer wall to deform, and
the deformation of the inner wall and the outer wall to cause the inner wall and the outer wall to move longitudinally relative to and in respective engagement with the plurality of first rolls and the at least one second roll.

14. The apparatus according to claim 1
and further comprising:
a plurality of first rolls, wherein the first rolls
are each engaged with the inner wall,
are each longitudinally disposed from each of the other first rolls,
at least one second roll, wherein the at least one second roll
is engaged with the outer wall,
is positioned longitudinally intermediate of an immediately longitudinally adjacent pair of first rolls,
wherein movement of the preform longitudinally relative to and in engagement with the first rolls and the at least one second roll is operative to straighten the shape of the preform,
wherein the valve is positioned longitudinally on a first side of each of the plurality of first rolls and the at least one second roll,
wherein fluid introduced to the gap through the valve is operative to cause
each of the inner wall and the outer wall to deform, and
the deformation of the inner wall and the outer wall to cause the inner wall and the outer wall to move longitudinally toward the first side relative to and in respective engagement with the plurality of first rolls and the at least one second roll.

15. The apparatus according to claim 1
wherein the valve and the gap are adapted to receive fluid comprising one or more of gas, air, water, oil, fluid concrete or fluid plastic.

16. Apparatus comprising:
a preform adapted to produce a longitudinal chamber profile element, including:
an inner wall, wherein the inner wall
is comprised of metal sheet,
is bounded by two opposed inner wall short edges and two opposed inner wall long edges,
an outer wall, wherein the outer wall
is comprised of metal sheet,
is bounded by two opposed outer wall short edges and two opposed outer wall long edges,
wherein the outer wall and the inner wall
are arranged with respective inner wall short edges and outer wall short edges in generally aligned relation and with respective inner wall long edges and outer wall long edges in generally aligned relation,
are sealed in fluid tight relation by a respective short seal at each respective immediately adjacent inner wall short edge and outer wall short edge,
are sealed in fluid tight relation by a respective long seal at each respective immediately adjacent inner wall long edge and outer wall long edge,
wherein a fluid tight sealed internal gap extends intermediate of the inner wall and outer wall and intermediate of the short seals and the long seals,
a valve, wherein the valve
is positioned on one of the inner wall or the outer wall, and
is adapted to enable the introduction of pressurized fluid to the gap,
wherein the longitudinal chamber profile preform prior to the introduction of pressurized fluid in the gap is coiled such that each of the long seals in a side view has a shape that is an outward expanding spiral that extends through an angle of at least 900°.

17. The apparatus according to claim 16
wherein the spiral is substantially an Archimedean spiral.

18. The apparatus according to claim 17
wherein the inner wall and the outer wall are convergent at each immediately adjacent inner wall short edge and outer wall short edge.

19. The apparatus according to claim 17
and further comprising:
a plurality of first rolls, wherein the first rolls
are each engaged with the inner wall,
are each longitudinally disposed from each of the other first rolls,
at least one second roll, wherein the at least one second roll
is engaged with the outer wall,
is positioned longitudinally intermediate of an immediately longitudinally adjacent pair of first rolls,
wherein movement of the preform longitudinally relative to and in engagement with the first rolls and the at least one second roll is operative to straighten the shape of the preform,
wherein fluid introduced to the gap through the valve is operative to cause
each of the inner wall and the outer wall to deform, and
the deformation of the inner wall and the outer wall to cause the inner wall and the outer wall to move longitudinally relative to and in respective engagement with the plurality of first rolls and the at least one second roll.

20. A method comprising:
a) providing a preform adapted to produce a longitudinal chamber profile element, that includes
an inner wall, wherein the inner wall
is comprised of metal sheet,
includes two opposite inner wall short edges and two opposite inner wall long edges, wherein a respective inner wall short edge bounds a respective end of the inner wall,
an outer wall, wherein the outer wall
is comprised of metal sheet,
includes two opposite outer wall short edges and two opposite outer wall long edges, wherein a respective outer wall short edge bounds a respective end of the outer wall,
a pair of short seals,
wherein each respective inner wall short edge is joined in sealed fluid tight relation with a respective outer wall short edge by a respective short seal,
a pair of long seals,
wherein each respective inner wall long edge is joined in sealed fluid tight relation with a respective outer wall long edge by a respective long seal,
wherein a hermetic sealed internal gap extends intermediate of the inner wall and the outer wall and intermediate of the short seals and the long seals,
a valve, wherein the valve
is positioned on one of the inner wall or the outer wall, and
is adapted to enable the introduction of pressurized fluid to the gap,
wherein the preform prior to the introduction of pressurized fluid into the gap is coiled such that each of the long seals in a side view have a shape that is substantially an Archimedean spiral,
b) delivering pressurized fluid into the gap through the valve and maintaining the fluid at a fluid pressure that is operative to cause each of the inner wall and the outer wall to deform and the shape of the spiral to uncoil.
